(19) United States
(12) Patent Application Publication
(10) Pub. No.: US 2004/0243854 A1
(43) Pub. Date: Dec. 2, 2004

(54) Password input apparatus

(75) Inventor: Byung Sung Lee, Kyungki do (KR)

Correspondence Address: BRUCE E. LILLING, LILLING & LILLING P.C., P.O. BOX 560, GOLDEN BRIDGE, NY, 10526, US

(73) Assignee: Mazetech Co., Ltd., Icheon (KR)

(21) Appl. No.: 10/489,649

(22) PCT Filed: Sep. 18, 2002
(86) PCT No.: PCT/KR02/01751

(30) Foreign Application Priority Data
Sep. 18, 2001 (KR) 2001/57595
Sep. 18, 2002 (KR) 2002/56817

(51) Int. Cl. H04L 9/32

(52) U.S. Cl. 713/202

(57) ABSTRACT

Disclosed relat to a password input apparatus that prevents the exposure of password to strangers while the user inputs the password, furthermore, prevents strangers from perceiving the password easily through distinctions of specific keys corresponding to the password due to repeated use. According to the invention, a series of password data (random digit string) are displayed on display elements (33) and the password data displayed are selected using selection keys (40) by a user. Here, the arrangement of the password data is varied every time when the user inputs the password. A display window (32), having a predetermined height, provided on the top of the display element (33), can narrow the angle of view against the light emitted from the display elements (33), thus preventing strangers other then the users standing in a straight line against the display element (33) from perceiving the passwordk easily.

### TECHNICAL FIELD

The present invention relates to a password input apparatus and, more particularly, to a password input apparatus that prevents the exposure of password to strangers while the user inputs the password, furthermore, prevents strangers from perceiving the password easily through distinctions of specific keys corresponding to the password due to repeated use.

### BACKGROUND ART

Recently, various equipments that demand user's password for operation have been developed and come into wide use. For example, automatic door device for opening door, and automated teller machine (ATM), from which user can draw his or her money, not from bank, are typical examples of the password input device.

FIG. 1 shows a front panel of a conventional device for inputting password, which includes a keypad 10 having a plurality of selection keys, such as numeral keys for inputting password corresponding to FIGS. 0 to 9 for example and function keys for selecting additional functions, and a display part 20 for displaying password data input by user. Accordingly, the user can operate the selection keys on the keypad 10, verifying selected numerals or password data corresponding to the selection keys displayed on the display part 20. However, since the display part 20 of the conventional device is installed externally, password data input by the user are easily exposed to strangers. In case of the conventional device for inputting password applied to the automatic door device for example, the user touches specific keys corresponding to the password fixed, which causes a serious problem that the specific keys touched by the user repeatedly are distinguished externally from the other keys not used. Of course, strangers who have bad intentions can catch user's password easily through the distinguished specific keys.

### DISCLOSURE OF INVENTION

Accordingly, the present invention is directed to a password input apparatus that substantially obviates one or more of the problems due to limitations and disadvantages of the related art.

An object of the present invention is to provide a password input apparatus that can solve a problem that only the specific keys corresponding to the password are repeatedly used.

Another object of the present invention is to provide a password input apparatus that prevents strangers standing around the user from perceiving the password easily.

To accomplish an object in accordance with a first object of the present invention, there is provided a password input apparatus comprising: a display means for displaying password data; a plurality of selection means for selecting specific password data among password data displayed on the displayed means; and a control means for controlling the display means to display the password data, and for checking if the password data corresponding to the selection means operated by a user is input.

To accomplish another object in accordance with the first aspect of the present invention, the control means of the password input apparatus outputs a predetermined number of password data through the display means simultaneously, and the corresponding number of the selection means are provided

To accomplish another object in accordance with the first aspect of the present invention, the display window having a specific height is established on a top of the display means of the password input apparatus.

To accomplish another object in accordance with the first aspect of the present invention, a light refracting means for restricting light output from the display means in a specific direction is provided on the top of the display means of the password input apparatus.

To accomplish another object in accordance with the first aspect of the present invention, the selection means of are installed on the top of the display means of the password input apparatus.

To accomplish another object in accordance with a second aspect of the present invention, there is provided a password input apparatus comprising: a display device; a plurality of selection keys for inputting password data; and a display window having a specific height established on a top of the display device, the height of the display window being set to a length that only a user standing in a straight line against the display device can recognize password data displayed on the display device.

To accomplish another object in accordance with a third aspect of the present invention, there is provided a password input apparatus comprising: at least an opening provided on a top of a main body case; a display elements mounted on a substrate positioned corresponding to the opening; a hat-shaped selection key, made of transparent material, including a groove, formed at a bottom thereof, for receiving the display element; at least an elastic member for supporting the selection key; and a switch located on the substrate and operated on and off according as the selection key is pressed downward.

### BRIEF DESCRIPTION OF DRAWINGS

FIG. 1 shows a front panel of a conventional device for inputting password;

FIG. 2 depicts an example of a front panel of a password input apparatus in accordance with the present invention;

FIG. 3 illustrates an example of a display part 30 in accordance with a preferred embodiment of the invention;

FIG. 4 shows a modified structure of the display part 30 in FIG. 3 in accordance with another embodiment of the invention;

FIGS. 5a and 5b depict another example of the display part 30 in accordance with another embodiment of the invention;

FIG. 6 is a block diagram showing a circuit configuration of the password input apparatus in accordance with the invention;

FIG. 7 is a flowchart illustrating overall operations of the apparatus in FIG. 6; and

FIG. 8 is a perspective view showing an example of the password input apparatus embodied in accordance with the invention.

### BEST MODE FOR CARRYING OUT THE INVENTION

Reference will now be made in detail to the preferred embodiments of the present invention, examples of which are illustrated in the accompanying drawings.

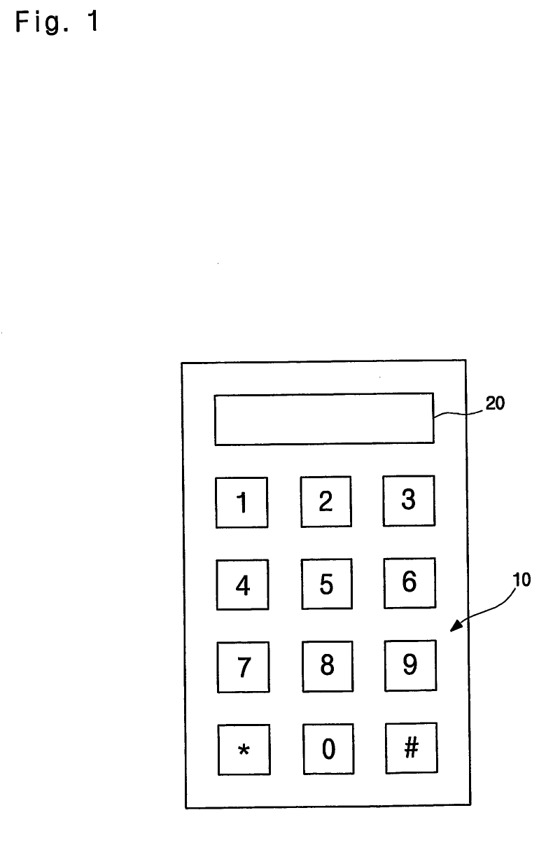

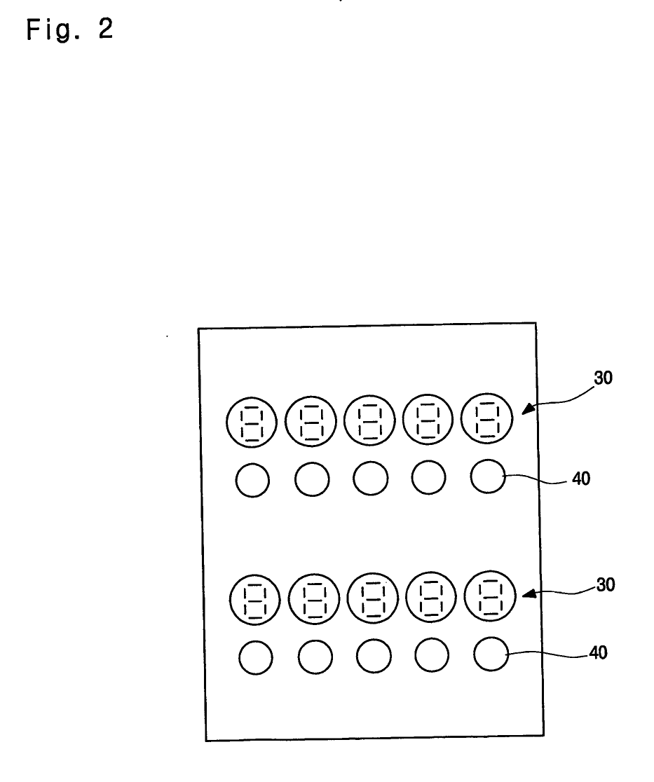

Now referring to FIG. 2 showing a front panel of a password input apparatus in accordance of the invention, where the password data are composed of FIGS. 0 to 9 only, a basic concept of the present invention will be described hereinafter.

The password input apparatus comprises a display part 30 for displaying password data of FIGS. 0 to 9, respectively, and a plurality of selection keys 40 for selecting the password data displayed on the display part 30. Here, the arrangement of the password data displayed on the display part 30 is varied every time when the user inputs the password. For example, when the user starts operating the apparatus, password data of the upper part of the display part 30 are shown “03957” and those of the lower part of the display part 30 are displayed “84261”, next time when the user operates the apparatus, the arrangement of the password data is varied in a manner that the upper part of the display part 30 shows “19458 and the lower part of the display part 30 displays “67203”. That is, the password input apparatus in accordance with the present invention alters the password data corresponding to each of the selection keys 40, which prevents the repeated use of specific keys and the exposure of the password to strangers standing around the user at a specific distance.

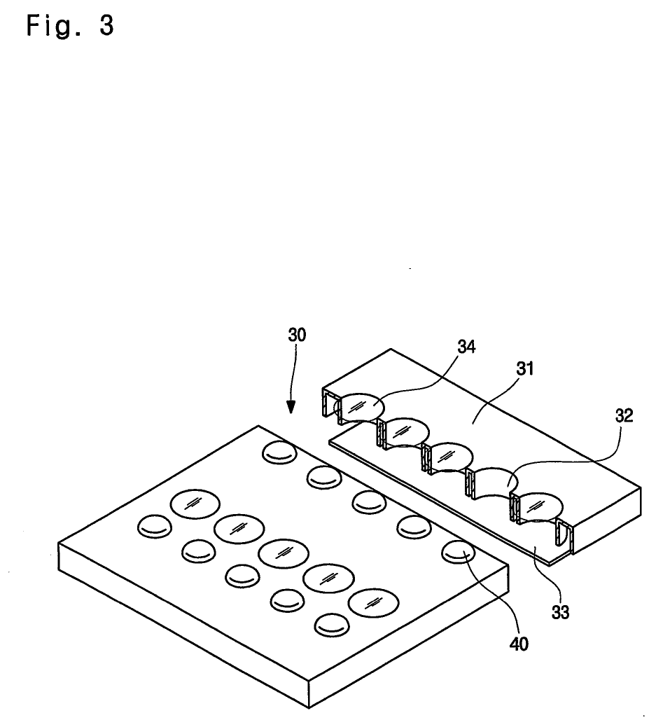

Next, referring to FIG. 3, the display part 30 described in FIG. 2 includes a main body case 31, which corresponds to a main body case of the apparatus itself or that of the automatic door equipment in which a password input apparatus of the invention is established. The case 31 includes a plurality of display windows 32 having a predetermined depth (height). A display element 33 for displaying password data, such as liquid crystal display (LDC) or 7-segment for example, is provided underneath the display windows 32. A plurality of covers 34, made of transparent material such as glass or acrylic, is put on the top of the display windows 32. The structure of the display part 30 described above can narrow the angle of view against output data of the display element 33, thus allowing only the user standing in a straight line against the apparatus of the invention to recognize the password data displayed. Accordingly, the display part 30 of the invention can prevent strangers standing around the user from perceiving the password.

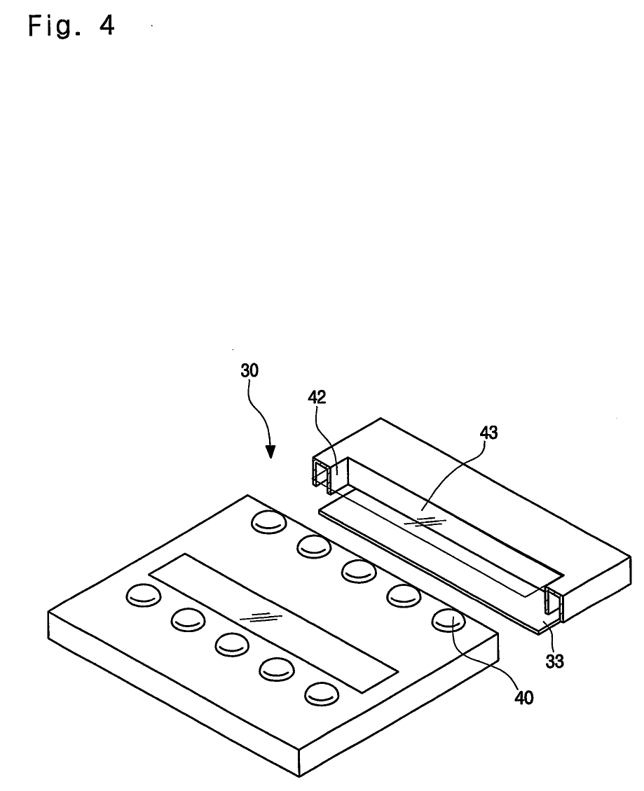

Referring to FIG. 4, showing another example of the display part 30 in accordance with another embodiment of the invention, substantially identical elements with those in FIG. 3 have the same reference numerals. According to the structure described with reference to FIG. 3, the plural display windows 32 are provided corresponding to each of the password data displayed on the display element 33, whereas, a single display window 42 is established corresponding to the single display element 33 for displaying plural password data, as shown in FIG. 4. Here, the size of the display window 42 is set to the extent that the user can recognize the password data displayed on the display element 33. However, it is desirable that the height of the display window 42, i.e., the length from a cover 43 to the display element 33 should be set not to allow the strangers located adjacent to the user to perceive the password data displayed on the display element 33.

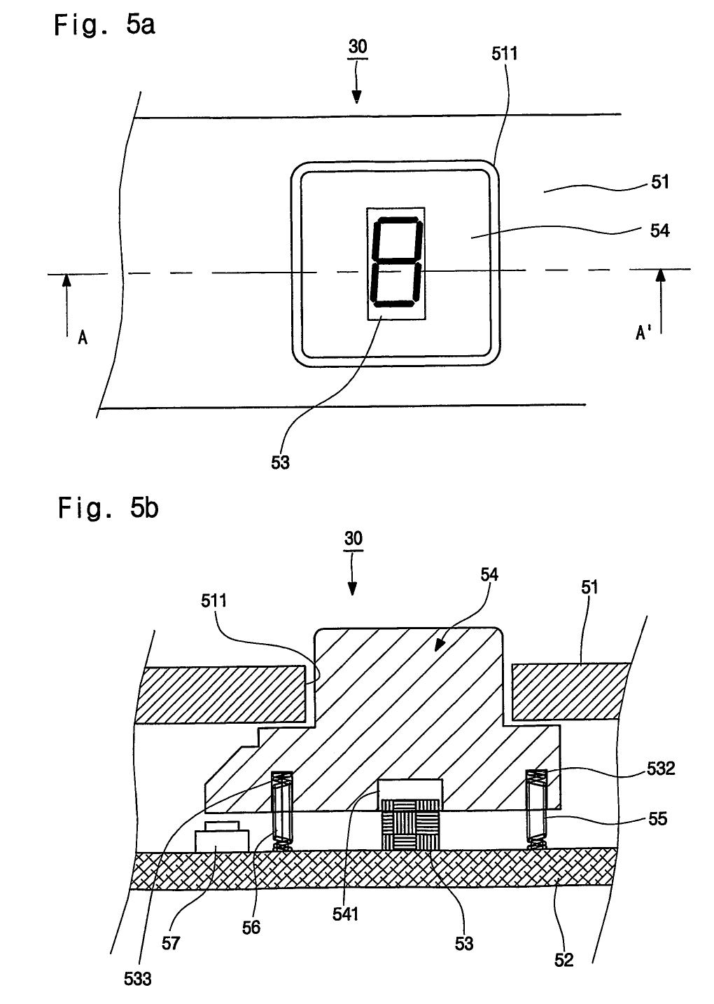

FIG. 5a and 5b also illustrate another example of the display part 30 in accordance with another embodiment of the invention. FIG. 5a is a top view of the display part 30 showing a single password datum and FIG. 5b is a sectional view cut along with a line of A-A′ in FIG. 5a. According to this embodiment, a selection key 54 is put on each of display elements 53, which simplifies the structure and facilitates the input of the password as well. In FIG. 5b, a main body case 51 has a plurality of openings 511 through which the selection keys 54 are accommodated. A printed circuit board PCB 52 on which electronic circuits are arranged is established inside the case 51. Each of the plural display elements 53, such as liquid crystal display (LDC) or 7-segment for example, is positioned within the openings 511. The number of the display elements 53 is set corresponding to the number of the openings 511, i.e., that of the password data. The selection key 54 made of transparent material, such as glass or acrylic, is provided on the top of each of the display elements 53. The selection key 54 is designed to have a hat shape that the width of lower part is larger than that of upper part, thus sitting over the display element 53, not detaching from the opening 511. Besides, the selection key 54 has a groove 541 at the bottom thereof for receiving corresponding display element 53. The selection key 54 further includes spring grooves 532 and 533 for receiving elastic springs 55 and 56 mounted on both sides of the display element 53 on the PCB 52, the elastic springs 55 and 56 supporting the selection key 54 elastically. Last, a tact switch 57 is provided at a predetermined position under the selection key 54. Accordingly, when the use pushes the selection key 54, the groove 541 of the key 54 doesn't come into contact with the top of the display element 53, the body of the selection key 54 turns on the switch 57 and, then, the selection key 54 returns upward by means of the elastic springs 55 and 56.

According to the structure described above, the display element 53 emits light outward through the body of the transparent selection key 54. Here, other light than the light emitted in a straight direction from the display element 53 is intercepted by the opaque main body case 51 surrounding the selection key 54. As a result, only the user standing in a straight line against the selection key 54 can perceive the password datum displayed on the display element 53. Besides, since the user recognizes the password data through the selection keys 54 and touches the keys 54 corresponding to the password data directly, there is no possibility that the user inputs wrong password by mistake.

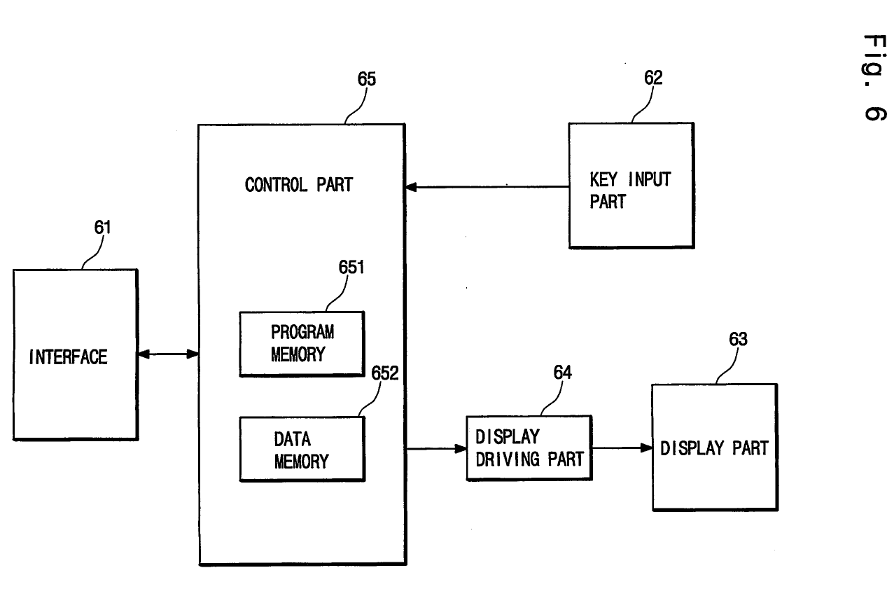

Next, referring to FIG. 6 showing a circuit configuration of the password input apparatus of the present invention; an interface 61 is to connect the password input apparatus with other peripheral unit, such as automatic door device, automated teller machine (ATM), personal computer, etc. Besides, to provide safer security, the apparatus of the invention can be interlocked with fingerprint recognition device, for example. Reference numeral 62 denotes a key input part for detecting the operation of the selection keys 40 described with reference to FIGS. 2 to 6; numeral 63 stands for the display part such as LCD or 7-segment; and numeral 64 indicates a display driving part for driving the display part 63 under the control of a control part 65 for controlling overall operations of the password input apparatus. The control part 65, composed of AT89C51/DIP microprocessor manufactured by Atmel Corporation for example, includes a program memory 651 and a data memory 652. The program memory 651 stores various programs for the operation of the control part 65, such as a predetermined interlocking program for interlocking with a peripheral unit and a password data generation algorithm for generating password data to be output through the display part 63. The password data generation algorithm adopts pseudo noise code (PN code) generation algorithm for example, which generates random digit strings of which digits are not overlapped with each other, in case that the password data are composed of FIGS. 0 to 9. That is, when the electric power is supplied to the password input apparatus, the control part 65 drives the algorithm to generate random digit strings continuously. And the random digit strings generated by the algorithm are selectively used when necessary. The data memory 652 storing various data processed by the control part 65 includes a first storing means for storing the output random digit strings and a second storing means for storing the password data. The first storing means stores a predetermined number of the past random digit strings most recently displayed on the display part 63. The random digit strings stored in the first storing means are compared when displaying a new random digit string on the display part 63, thus prohibiting the password data having the same random digit string with the previous one from being displayed on the display part 63. The second storing means stores the present random digit string, i.e., the password data being displayed on the display part 63 at present. The second storing means allots a peculiar memory address to each of the selection keys 40. That is, when displaying a specific random digit string on the display part 63, the control part 65 stores the respective password data displayed on the display part 63 in the second storing means according to the memory addresses corresponding to the respective selection keys 40. And, when the user touches a specific selection key 40, the control part 65 reads a password datum of the memory address corresponding to the selection key 40 touched by the user and transmits it to the interface 61.

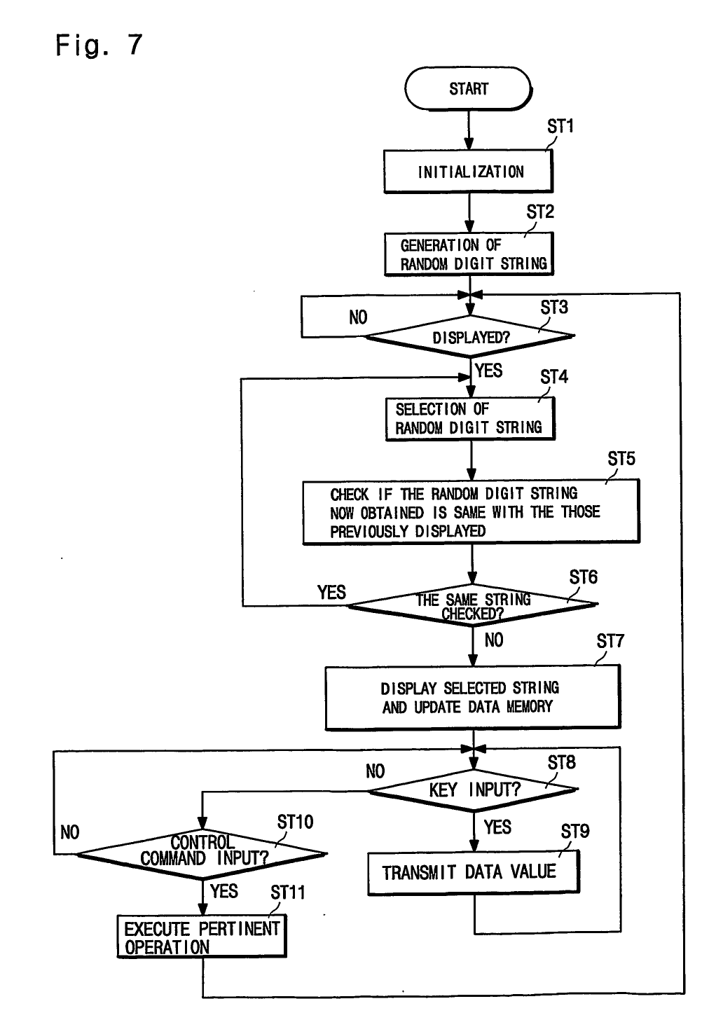

With reference to a flowchart in FIG. 7, overall operations of the apparatus in FIG. 6 will be described hereinafter. First, when the electric power is applied to the apparatus, the control part 65 executes an initialization process, such as checking memory, peripheral unit, etc. (ST1). Then, the control part 65 drives the password data generation algorithm to generate random digit strings continuously (ST2). The random digit string generated in the step 2 (ST2) is displayed on the display part 63 in accordance with a specific outside command (ST3). That is, if command data for displaying password data is received from the interface 61, or if the user operates selection keys 40, the control part 65 executes a control process for displaying password data in accordance with the random digit string generated. Then, the control part 65 stores the random digit string, output from the password data generation algorithm at the time when the outside command is received (ST4), and refers to the first storing means of the data memory 652 to check if the random digit string obtained just now is same with the those previously displayed (ST5 and ST6). Here, if so, the control part 65 repeats the steps 4 to 6 until a new random digit string, not displayed lately, is obtained.

If the new random digit string is decided through the steps 4 to 6, the control part 65 controls the display driving part 64 to display the random digit string, i.e., password data on the display part 63, and updates the data memory 652 based on the random digit string (ST7). That is, the control part 65 updates the first storing means of the data memory 652, based on the decided random digit string, and stores the corresponding password data displayed on the display part 63 in the second storing means.

Next, if the user looks at the password data displayed on the displayed part 53 and touches corresponding selection keys (ST8), the control part 65 reads data values corresponding to the touched selection keys from the second storing means of the data memory 652 and transmit the values through the interface 61 (ST9). If a predetermined control command is input through the interface 61 from the peripheral unit, the control part 65 executes pertinent operations in accordance with the commands (ST10 and ST11). The control commands include various status data, such as “OPEN” if input password data are correct or “FAIL” if wrong, for example where the automatic door device is interlocked with the password input apparatus of the invention. The control commands can be varied in accordance with the peripheral unit interlocked with the apparatus of the invention.

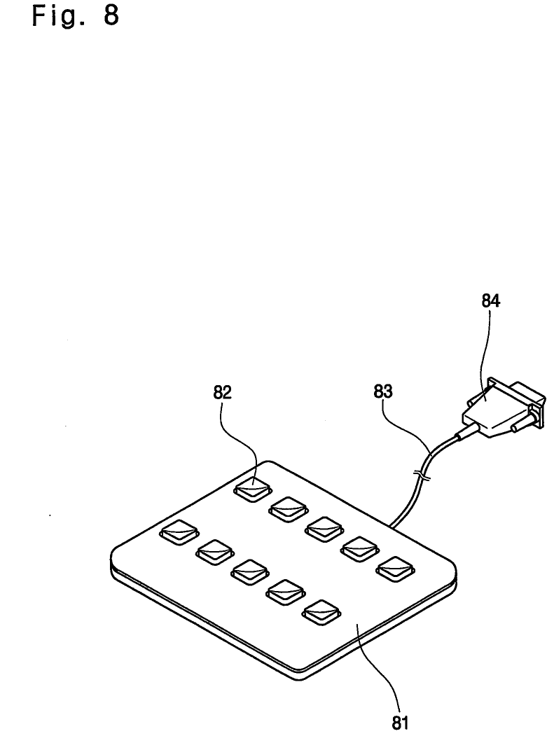

Next, referring to FIG. 8 showing an example of the password input apparatus embodied in accordance with the present invention, the apparatus can be applied to the end that the visitor inputs its password directly at a bank window for example. The apparatus in FIG. 8 includes a plurality of selection key 82 on the top of a main body case 81. The selection keys 81 are made of transparent material as described with reference to FIG. 5. Besides, a predetermined number of display elements, not depicted, corresponding to the selection keys 81 are established inside the case 81. An end of a cable 83 is connected to the circuit inside the case 81 and the other end of the cable 83 has a connector 84 for interlocking with a banker's terminal for example. In this case, the banker's terminal and the password input apparatus stores a predetermined interlocking program, respectively, for interlocking with each other. If the visitor's password is needed to transact the visitor's business, the banker provides the password input apparatus with the visitor and, then, operates specific keys established on the banker's terminal. According to the key operation by the banker, a predetermined control command for displaying password data is applied from the banker's terminal to the password input apparatus. That is, the control command is applied from the interface 61 to the control part 65 in FIG. 6. When the control command is received from the banker's terminal, the control part 65 executes the processes described in the steps 4 to 7 to display password data of random digit string on the apparatus. Subsequently, if the visitor reads the password data displayed on the apparatus and inputs its password by touching the selection keys 82, the password input by the visitor are checked by the control part 65 and transmitted to the banker's terminal. Then, the terminal decides if the password received from the apparatus is the one registered normally. If the password is decided wrong, or if the visitor doesn't input the password within a predetermined time assigned, the terminal transmits a predetermined control command to the apparatus in order to inform the visitor of the input error. Here, the input error information can be provided to the banker through the banker's terminal, instead of the visitor through the apparatus supplied from the banker.

According to the apparatus described above, the password the user inputs is not exposed to strangers including the banker, which enables the visitor to do a safer financial transaction from the visitor's point of view.

Meanwhile, the present invention can be embodied with various modifications and variations, not limited to the embodiments described above. For example, the examples depicted in FIGS. 2 and 4 provide display windows 32 and 42 having a predetermined height, respectively, on the top of display element 33, whereas an identical effect can be obtained by substituting other means for restricting the light emitted from the display element 33 within the user's visual angle, such as prism for refracting the emitted light.

Besides, the example in FIG. 5b discloses a button type selection key with the tact switch on the tope of the display element 53, whereas it is possible to adopt other selection means, such as a touch screen.

Furthermore, according to FIGS. 2 and 8, the examples have the selection keys for selecting only the password data including decimal FIGS. 0 to 9, whereas it is possible to establish other function keys for selecting additional functions, such as START key for starting input of password, RESET key for re-inputting password, etc. In these embodiments, the password input apparatus transmits the password data input by the user to the peripheral unit, whereas it is possible to establish a means for deciding if the password is correct in the apparatus.

In addition, it is described that the password input apparatus of the invention uses a predetermined password data generation algorithm for generating random digit strings to be displayed on the display elements of the display part, whereas it is possible to obtain the same effect in such a manner that a series of passwords data composed of digit strings stored in a memory are randomly output to display instead of the password data generation algorithm.

It will be apparent to those skilled in the art that various modifications and variations can be made in the password input apparatus of the present invention without departing from the spirit or scope of the invention. Thus, it is intended that the present invention cover the modifications and variations of this invention provided they come within the scope of the appended claims and their equivalents.

Industrial Applicability

The password input apparatus of the present invention can be interlocked with various equipments that need high security, such as automatic door device for opening door, automated teller machine (ATM), etc., which prevents the exposure of password to strangers while the user inputs the password and, furthermore, prevents strangers from perceiving the password easily through distinctions of specific keys corresponding to the password.

1. A password input apparatus comprising:
a display means for displaying password data;
a plurality of selection means for selecting specific password data among password data displayed on the displayed means; and
a control means for controlling the display means to display the password data, and for checking if the password data corresponding to the selection means operated by a user is input.

2. The password input apparatus as recited in claim 1, wherein the control means outputs a predetermined number of password data through the display means simultaneously, and the corresponding number of the selection means are provided.

3. The password input apparatus as recited in claim 1, wherein a display window having a specific height is established on a top of the display means.

4. The password input apparatus as recited in claim 1, wherein a light refracting means for restricting light output from the display means in a specific direction is provided on the top of the display means.

5. The password input apparatus as recited in claim 1, wherein the selection means are installed on the top of the display means.

6. The password input apparatus as recited in claim 1, wherein the selection means are composed of button-type keys made of transparent material.

7. The password input apparatus as recited in claim 1, wherein the selection means are a touch screen.

8. The password input apparatus as recited in claim 1, wherein the control part alters arrangements of password data output through the display means every time when a user inputs a specific password.

9. A password input apparatus comprising:
a display device;
a plurality of selection keys for inputting password data; and
a display window having a specific height established on a top of the display device, the height of the display window being set to a length that only a user standing in a straight line against the display device can recognize password data displayed on the display device.

10. A password input apparatus comprising:
at least an opening provided on a top of a main body case;
a display elements mounted on a substrate positioned corresponding to the opening;
a hat-shaped selection key, made of transparent material, including a groove, formed at a bottom thereof, for receiving the display element;
at least an elastic member for supporting the selection key; and
a switch located on the substrate and operated on and off according as the selection key is pressed downward.
